(19) United States
(12) Patent Application Publication
(10) Pub. No.: US 2007/0280688 A1
(43) Pub. Date: Dec. 6, 2007

(54) Upgradeable optical hub and hub upgrade

(75) Inventor: Xiao A. Shen, San Bruno, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Matisse Networks

(21) Appl. No.: 11/790,066

(22) Filed: Apr. 23, 2007

Related U.S. Application Data
(60) Provisional application No. 60/793,728, filed on Apr. 21, 2006.

(51) Int. Cl. H04J 14/00; H04B 10/20

(52) U.S. Cl. 398/59

(57) ABSTRACT

An upgradeable optical hub and hub upgrade can be provided. The upgradeable hub can separate an incoming signal into various components and provide a segment of the incoming signal to a port for a hub upgrade. The hub can drop, for example, four channels to four external nodes. Hub upgrade can separate an incoming signal into various bands, and can drop, for example, four channels to four external nodes. The upgradeable hub, thus, can be upgraded by adding the hub upgrade, without the need for discarding the original hub when performing a hub upgrade.

### CROSS REFERENCE TO RELATED APPLICATIONS

This application is related to, claims the priority of, and incorporates by reference the entire disclosure of U.S. Provisional Patent Application No. 60/793,728, filed Apr. 21, 2006.

### BACKGROUND OF THE INVENTION

1. Field of the Invention

The present invention generally relates to communications technology, and especially optical communications technology. Certain embodiments of the present invention, for example relate to fiber optic communications in an optical ring topology, and provide a hub, hub upgrade, and methods and systems thereof.

2. Description of the Related Art

An optical hub can connect two or more external nodes to a single point in a fiber-optic network. A given hub may be able to accommodate a fixed maximum number of nodes. In certain cases, that number can be four. It may be possible to design hubs with a greater number of supported nodes. Such a design, however, can increase the cost and complexity of the hub.

Nevertheless, although a small number of external nodes may initially be connected to the hub, this number can change. Thus, for example, it may be desirable to add further nodes above the maximum without creating additional breaks in a fiber backbone. One option is to replace a simple initial hub with a small maximum number of possible external nodes with a larger hub that can accommodate more possible external nodes.

Similarly, it may be possible that a given hub can be under-utilized for an extended period of time, because there is no need for the number of external nodes to approach the maximum.

It may, therefore, be valuable to balance the cost of initial implementation of such a hub with the cost of upgrading/downgrading a hub to accommodate more or fewer nodes.

Accordingly, a need exists for a field-upgradeable BASE hub that can be upgraded with an UPGRADE hub, without requiring replacement of any equipment. Existing channels should not suffer traffic hits when upgrade channels are added to the network. Furthermore, it may be needed to provide a system from which an UPGRADE hub can be removed, so that, for example, the UPGRADE hub can be relocated to another part of an optical network where additional external nodes need connection to a BASE hub, without requiring any additional equipment.

### SUMMARY OF THE INVENTION

Certain embodiments of the present invention can, for example, can meet the needs described above by providing an upgradeable optical hub, an optical hub upgrade, and systems and methods thereof.

One embodiment of the present application is an upgradeable optical hub including a fiber-in interface and a fiber-out interface. The optical hub also includes a demultiplexer filter configured to drop a selected wavelength of an input optical signal received at the fiber-in interface. The optical hub further includes a multiplexer filter configured to add a selected wavelength of an output optical signal to be provided at the fiber-out interface. The optical hub additionally includes wide optical couplers configured to multiplex dense wavelength division multiplexing (DWDM) wavelengths and add them to the input optical signal. The optical hub also includes a wide optical coupler configured to add a channel from a hub upgrade to the output optical signal. The optical hub further includes a first control element configured to separate the input optical signal into a base portion and an upgrade portion, and to provide the upgrade portion at an output of the hub. The optical hub additionally includes a second control element configured to receive an upgrade portion from an input of the hub and to combine it with the base portion. The optical hub also includes an optical isolator connected to the first control element and configured to drop a band of the base portion. The optical hub further includes a dropped band output configured to provide the band to one or more external nodes. The optical hub additionally includes a power monitor configured to monitor transmit power from the one or more external nodes. The optical hub also includes a transceiver configured to provide a respective signaling channel to the one or more external nodes.

Another embodiment of the present invention is an optical hub upgrade including wide optical couplers configured to multiplex dense wavelength division multiplexing wavelengths and add them to an input optical signal. The optical hub upgrade also includes a first control element configured to separate an input upgrade portion from an optical hub into a plurality of bands and to provide proper amplification for each band. The optical hub upgrade further includes a second control element configured to provide an output upgrade portion to an input of the optical hub for combination with a base portion. The optical hub upgrade additionally includes an optical isolator connected to the first control element and configured to drop a band of the upgrade portion. The optical hub upgrade also includes a dropped band output configured to provide the band to one or more external nodes. The optical hub upgrade further includes a power monitor configured to monitor transmit power from the one or more external nodes. The optical hub upgrade additionally includes a transceiver configured to provide a respective signaling channel to the one or more external nodes.

A further embodiment of the present invention is an optical hub system that includes an upgradable optical hub and a hub upgrade. The optical hub includes a fiber-in interface and a fiber-out interface. The optical hub also includes a demultiplexer filter configured to drop a selected wavelength of an input optical signal received at the fiber-in interface. The optical hub further includes a multiplexer filter configured to add a selected wavelength of an output optical signal to be provided at the fiber-out interface. The optical hub additionally includes wide optical couplers configured to multiplex dense wavelength division multiplexing wavelengths and add them to the input optical signal. The optical hub also includes a wide optical coupler configured to add a channel from a hub upgrade to the output optical signal. The optical hub further includes a first control element configured to separate the input optical signal into a base portion and an upgrade portion, and to provide the upgrade portion at an output of the hub. The optical hub additionally includes a second control element configured to receive an upgrade portion from an input of the hub and to combine it with the base portion. The optical hub also includes an optical isolator connected to the first control element and configured to drop a band of the base portion. The optical hub further includes a dropped band output configured to provide the band to one or more external nodes. The optical hub additionally includes a power monitor configured to monitor transmit power from the one or more external nodes. The optical hub also includes a transceiver configured to provide a respective signaling channel to the one or more external nodes. The hub upgrade includes a second plurality of wide optical couplers configured to multiplex second dense wavelength division multiplexing wavelengths and add them to an input optical signal. The hub upgrade also includes a third control element configured to separate an input upgrade portion from the optical hub into a plurality of bands and to provide proper amplification for each band. The hub upgrade further includes a fourth control element configured to provide an output upgrade portion to the wide optical coupler for combination with the base portion. The hub upgrade additionally includes a second optical isolator connected to the third control element and configured to drop a second band of the upgrade portion. The hub upgrade also includes a second dropped band output configured to provide the second band to a second one or more external nodes. The hub upgrade further includes a second power monitor configured to monitor transmit power from the second one or more external nodes. The hub upgrade additionally includes a second a transceiver configured to provide a respective signaling channel to the second one or more external nodes.

A further embodiment of the present invention is a method including providing fiber-in and fiber-out interfaces with an optical network. The method also includes dropping an incoming wavelength received at the fiber-in interface. The method further includes adding an outgoing wavelength to be provided to the fiber-out interface. The method additionally includes adding dense wavelength division multiplexing wavelengths from external nodes to the incoming wavelength. The method also includes adding upgrade wavelengths to the outgoing wavelength. The method further includes separating the incoming wavelength into base and upgrade portions. The method additionally includes providing the upgrade portion to a port for processing by an upgrade hub. The method also includes separating the base portion into a plurality of bands. The method further includes dropping one band of the plurality of bands to the external nodes. The method additionally includes monitoring incoming transmit power from the external nodes. The method also includes terminating local traffic from the external nodes.

Another embodiment of the present invention is a method including adding dense wavelength division multiplexing wavelengths from a plurality of external nodes to an input signal received from an optical hub. The method also includes separating the input signal into a plurality of bands. The method further includes dropping one band of the plurality of bands to the external nodes. The method additionally includes monitoring incoming transmit power from the external nodes. The method also includes terminating local traffic from the external nodes.

A further embodiment of the present invention is an upgradable optical hub including input interface means for communicating with a fiber network. The optical hub also includes output interface means for communicating with the fiber network. The optical hub further includes demultiplexer means for dropping a selected wavelength of an input optical signal received at the input interface means. The optical hub additionally includes multiplexer means for adding a selected wavelength of an output optical signal to be provided at the output interface means. The optical hub also includes a plurality of wide optical coupling means for multiplexing dense wavelength division multiplexing wavelengths and adding them to the input optical signal. The optical hub further includes a wide optical coupling means for adding a channel from a hub upgrade to the output optical signal. The optical hub additionally includes first control means for separating the input signal into a base portion and an upgrade portion, and for providing the upgrade portion at an output of the hub. The optical hub also includes second control means for receiving an upgrade portion from an input of the hub and combining it with the base portion. The optical hub further includes optical isolation means for dropping a band of the base portion. The optical hub additionally includes dropped band output means for providing the band to one or more external nodes. The optical hub also includes power monitor means for monitoring transmit power from the one or more external nodes. The optical hub further includes a transceiver means for providing a respective signaling channel to the one or more external nodes.

An additional embodiment of the present invention is an optical hub upgrade that includes a plurality of wide optical coupling means for multiplexing dense wavelength division multiplexing wavelengths and adding them to an input optical signal. The optical hub upgrade also includes first control means for separating an input upgrade portion from an optical hub into a plurality of bands and for providing proper amplification for each band. The optical hub upgrade further includes second control means for providing an output upgrade portion to an input of the optical hub for combination with a base portion. The optical hub upgrade additionally includes optical isolation means for dropping a band of the upgrade portion. The optical hub upgrade also includes dropped band output means for providing the band to one or more external nodes. The optical hub upgrade further includes power monitor means for monitoring transmit power from the one or more external nodes. The optical hub upgrade additionally includes a transceiver means for providing a respective signaling channel to the one or more external nodes.

### BRIEF DESCRIPTION OF THE DRAWINGS

For proper understanding of the invention, reference should be made to the accompanying drawings, which illustrate rather than limit.

FIG. 1 illustrates a block diagram of an upgradeable optical hub according to an embodiment of the present invention.

FIG. 2 illustrates a block diagram of an optical hub upgrade according to an embodiment of the present invention.

FIG. 3 illustrates a method according to an embodiment of the present invention.

FIG. 4 illustrates another method according to another embodiment of the present invention.

### DETAILED DESCRIPTION OF THE PREFERRED EMBODIMENT(S)

A hub module can implement a multiplexing section of a physical layer. It can contain all the optical elements of an optical hub product except a transponder, such as the 10.709 Gbps transponder. Of course, there is no requirement that the transponder be separate. Thus, a BASE hub can be provided either with or without a transponder.

There are two different main categories of hubs to be discussed below: BASE hubs and UPGRADE hubs. A BASE hub may also be referred to, interchangeably, as an upgradeable hub. An UPGRADE hub may also be referred to, interchangeably, as an optical hub upgrade. Each type of hub has, in a typical installation, four flavors, where each flavor handles one band of four wavelengths. When UPGRADE hubs are used, each BASE hub can have an UPGRADE hub connected to it. Accordingly, a network may, for example, contain one to four BASE hubs with a total network capacity of sixteen wavelengths, or (when UPGRADEs are used) eight to thirty-two wavelengths.

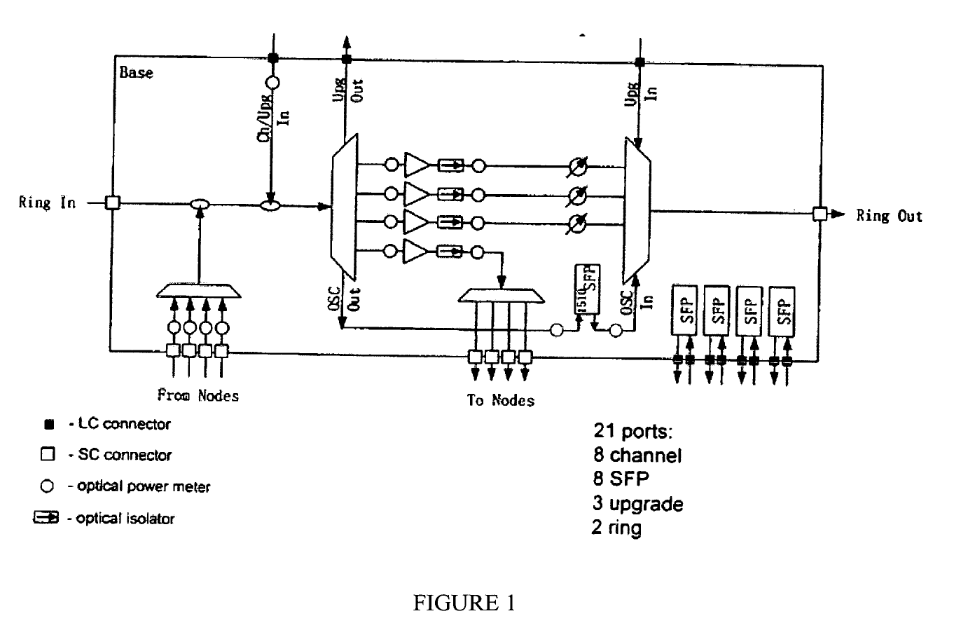

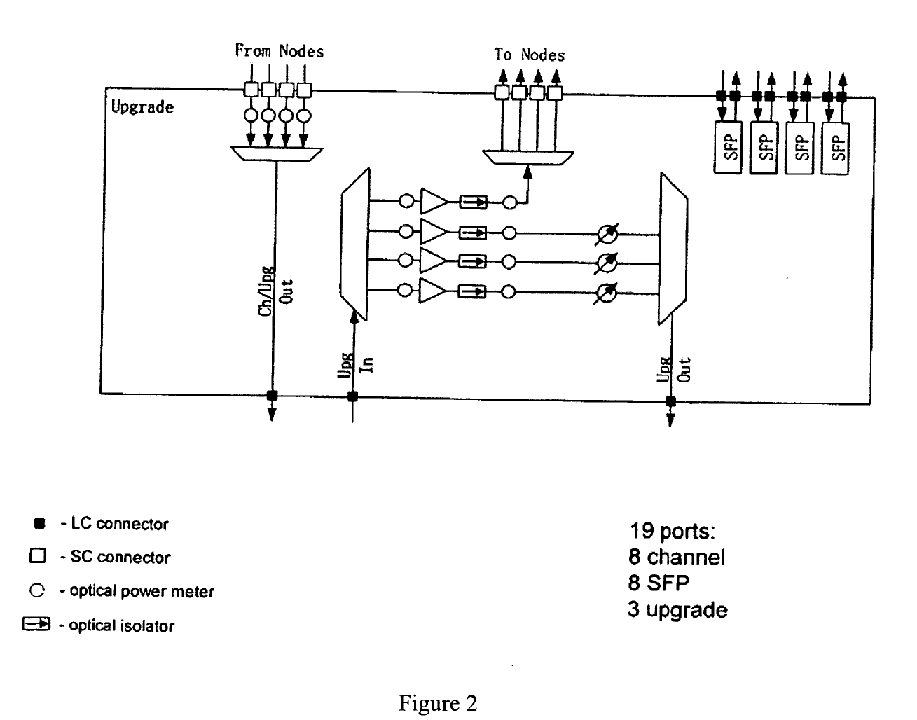

In FIGS. 1 and 2, a first flavor of UPGRADE hub and BASE hub are shown, in accordance with an embodiment of the present invention. Note that the first flavor drops the band that is shown lowest in the drawing. A second flavor of UPGRADE hub and BASE hub may respectively drop a band that is second from lowest, and so on. Since the UPGRADE bands can be separate from the BASE bands, the flavor of the UPGRADE hub does not necessarily have to match that of the BASE hub.

These numbers provided above are for an unprotected configuration running over a single typical fiber. In a protected configuration with full equipment redundancy, the total (unprotected) capacity can be doubled.

The BASE hub can connect to the backbone through two SingleMode fibers, one fiber for input and one fiber for output. The BASE hub can demultiplex, for example, the 2.67 Gbps 1510 nm optical supervisory channel (OSC) signal from the input and terminate it in an small form-factor pluggable (SFP) transceiver. The optical supervisory channel signal transmitted from the small form-factor pluggable transceiver can be multiplexed to the output fiber.

The UPGRADE hub does not have to connect directly to the backbone but can connect into the BASE hub, using, for example, three SingleMode fiber jumpers. It also does not have to terminate the backbone optical supervisory channel. Rather, the optical supervisory channel can be switched between the BASE and UPGRADE hubs electrically through a midplane.

Each type of hub can handle a different part of the C-band (1529.55-1558.17 nm). The BASE hub can be the one doing the spectral separation, after which each hub module demultiplexes its respective portion (BASE—1545.32 nm-1558.17 nm, UPGRADE—1529.55 nm-1542.14 nm) into four different bands, each one carrying up to 4 channels at 100 GHz spacing. Each of the bands can be amplified as needed, and one band in each hub can be demultiplexed into four individual channels. Similarly, the transmit signal coming from each of the one to four transponders connected to each hub can be multiplexed to the input fiber, enabling local optical switching regardless of network failures (i.e. even if both ring input and output from the BASE hub are disconnected, all eight nodes connected to the BASE and UPGRADE hubs can communicate without restrictions, as a cluster).

The functions of the BASE hub can include providing Fiber-In and Fiber-Out Interfaces to the network. The BASE hub can connect to the backbone using two SingleMode fibers. Optical signals enter from the fiber-in interface and exit from the fiber-out interface.

The BASE hub can also drop the incoming 1510 nm optical supervisory channel. The BASE hub can drop the 1510 nm wavelength to a 2.67 Gbps small form-factor pluggable transceiver by using a 1510/1550 nm demultiplexer filter.

The BASE hub can further add the outgoing 1510 nm OSC. The BASE hub can add to the ring the 1510 nm optical supervisory channel from the 2.67 Gbps small form-factor pluggable transceiver by using a 1510/1550 nm multiplexer filter.

Adding the transmitted dense wavelength division multiplexing wavelengths can also be performed by the BASE hub. By using several wide optical couplers, the hub can multiplex the transmitted dense wavelength division multiplexing wavelengths and add them to the input signal, from which they can either be dropped by the BASE or UPGRADE hubs, or can propagate further to remote hubs.

Likewise, adding the transmitted UPGRADE wavelengths can be a function of the BASE hub. By using a wide optical coupler, the BASE hub can receive the one to four multiplexed channels from the UPGRADE hub and can combine them to the input signal, from which they can be dropped by either the BASE or UPGRADE hubs, or can propagate further to remote hubs.

The BASE hub can also separate the C-band into BASE and UPGRADE portions. The BASE hub can separate the Upgrade portion from the rest of the C-band and send it to the UPGRADE hub. Traffic received from the UPGRADE hub is recombined with the BASE traffic and sent to the output. All BASE dense wavelength division multiplexing bands other than the one that is dropped are passed through (after being split, amplified, and recombined).

The BASE hub can also function to gain control. The BASE hub can separate the BASE portion of the C-band into four bands and provide proper amplification for each band, whether express (to be passed through the hub) or drop. Since the gain of the optical amplifier is fixed, a variable optical attenuator (VOA) can be controlled to ensure the correct power levels in the network. Optical power meters before and after each linear optical amplifier (LOA) can enable constant monitoring of the gain of each amplifier, so alarms can be generated if linear optical amplifiers age or fail.

Dropping one four-channel band can also be a function of the BASE hub. The BASE hub can amplify and drop one dedicated wavelength band. All dense wavelength division multiplexing wavelength bands other than the one that is dropped can be passed through (after being split, amplified, and recombined).

Another function of the BASE hub can be to providing monitoring. The BASE hub can provide a power monitoring function for the incoming transmit power from each node, and can also measure the total incoming power from the UPGRADE hub. In addition, transmit and receive power of the optical supervisory channel can be measured, and power coming from the UPGRADE hub can be monitored.

The BASE hub also can perform the function of terminating local optical supervisory channel traffic. The BASE hub can contain up to four local 1310 nm optical supervisory channel transceivers, which can provide a respective signaling channel to each of the nodes.

The functions of the UPGRADE hub can include adding the transmitted dense wavelength division multiplexing wavelengths. By using several wide optical couplers, the UPGRADE hub can multiplex the transmitted dense wavelength division multiplexing wavelengths and add them to the input signal, from which they can either be dropped by the BASE or UPGRADE hubs, or can propagate further to remote hubs.

The functions of the UPGRADE hub can also include gaining control. The UPGRADE hub can separate the shorter wavelength portion of the C-band into four bands and provides proper amplification for each band, whether express or drop. Since the gain of the optical amplifier can be fixed, a variable optical attenuator (VOA) can be controlled to ensure the correct power levels in the network. Optical power meters before and after each linear optical amplifier can enable constant monitoring of the gain of each amplifier, so that alarms can be generated if linear optical amplifiers age or fail.

The UPGADE hub can also drop one four-channel band. The UPGRADE hub can amplify and drop one dedicated wavelength band from the shorter wavelength portion of the C-band. All dense wavelength division multiplexing wavelength bands other than the one that is dropped can be passed through (after being split, amplified, and recombined).

The UPGRADE hub can further provide monitoring. The UPGRADE hub can provide a power monitoring function for the incoming transmit power from each node.

Another function of the UPGRADE hub can include termination of local optical supervisory channel traffic. The UPGRADE hub can contain up to, for example, four local 1310 nm optical supervisory channel transceivers, which can provide a respective signaling channel to each of the nodes.

FIG. 1 illustrates a BASE hub module in accordance with an embodiment of the present invention. In this embodiment, an optical signal enters from the Ring-in interface to a filter cassette. The incoming 1510 nm optical supervisory channel signal is dropped to the 2.67 Gbps transceiver, is processed by the FPGA, and is switched to up to, for example, four 1310 nm small form-factor pluggable transceivers (each corresponding to a different transponder connected to the hub) and to the UPGRADE hub (via a midplane). The 1510 nm optical supervisory channel transmit signal is sent to the network via a filter within the band cassette.

C-band traffic is split into two portions, for example, 1545.32 nm-1558.17 nm and 1529.55 nm-1542.14 nm. The shorter wavelengths are sent to the UPGRADE hub, and the longer wavelengths are demultiplexed into four bands, each of which continues to the active optics. There, the power of each band is measured, amplified, measured again and then attenuated. One band, specific to each hub flavor, is demultiplexed into its four constituent channels. The other three bands are recombined and sent to the output. The power of each incoming transponder signal is measured, and all signals (from one to four) are combined using wideband couplers and are added to the input. Power added from the upgrade hub is also measured (in the bring-up stage) and added to the input.

FIG. 2 illustrates an UPGRADE hub module in accordance with an embodiment of the present invention. The optical signal coming from the BASE hub is demultiplexed into four bands, each of which continues to the active optics. There (in the active optics), the power of each band is measured, amplified, measured again, and then attenuated. One band, specific to each hub flavor, is demultiplexed into its constituent channels. The other three bands are recombined and sent to the BASE hub. The electrical optical supervisory channel signal coming from the BASE hub through the midplane is processed by the FPGA and is switched to up to four 1310 nm small form-factor pluggable transceivers, each corresponding to a different transponder connected to the hub. The power of each incoming transponder signal is measured and all signals (from one to four) are combined using wideband couplers and are sent to the BASE hub.

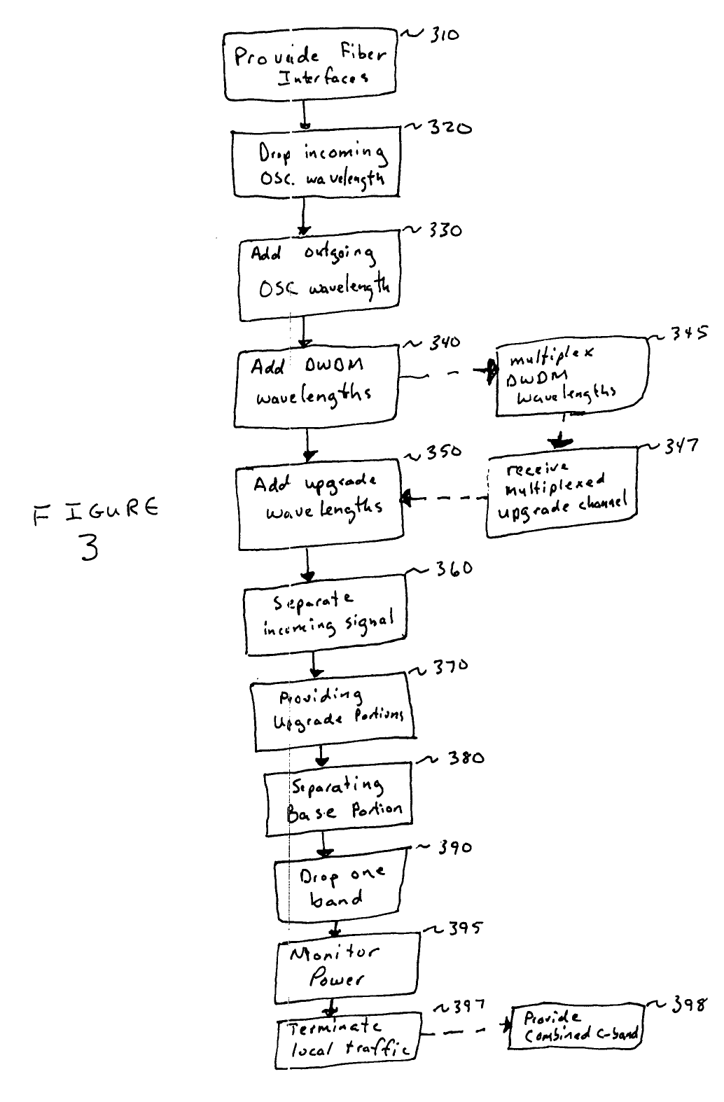

FIG. 3 illustrates a method according to an embodiment of the present invention. The method includes providing 310 fiber-in and fiber-out interfaces with an optical network.

The method also includes dropping 320 an incoming wavelength received at the fiber-in interface. The dropping 320 of the incoming wavelength can include dropping a 1510 nm wavelength to a 2.67 Gbps small form-factor pluggable transceiver.

The method further includes adding 330 an outgoing wavelength to be provided to the fiber-out interface. The adding 330 of the outgoing wavelength can include adding a 1510 nm wavelength from a 2.67 Gbps small form-factor pluggable transceiver to the fiber-out interface.

The method additionally includes adding 340 dense wavelength division multiplexing wavelengths from external nodes to the incoming wavelength. The method also includes adding 350 upgrade wavelengths to the outgoing wavelength.

The method further includes separating 360 the incoming wavelength into base and upgrade portions. The separating 360 of the incoming wavelength can include separating a c-band of the input signal into the base portion and the upgrade portion.

The method additionally includes providing 370 the upgrade portion to a port for processing by an upgrade hub. The method also includes separating 380 the base portion into a plurality of bands. The separating 380 of the base band can include separating the base portion into four bands, including the band that is dropped by the optical isolator, and providing respective amplification for each band of the four bands.

The method further includes dropping 390 one band of the plurality of bands to the external nodes. The method additionally includes monitoring 395 incoming transmit power from the external nodes. The monitoring 395 can further include monitoring a total incoming power from the hub upgrade.

The method also includes terminating 397 local traffic from the external nodes. The method can also include providing 398 a combined c-band to the fiber-out interface. The method can include multiplexing 345 dense wavelength division multiplexing wavelengths transmitted from the external nodes. The method can also include receiving 347 a multiplexed channel from the hub upgrade.

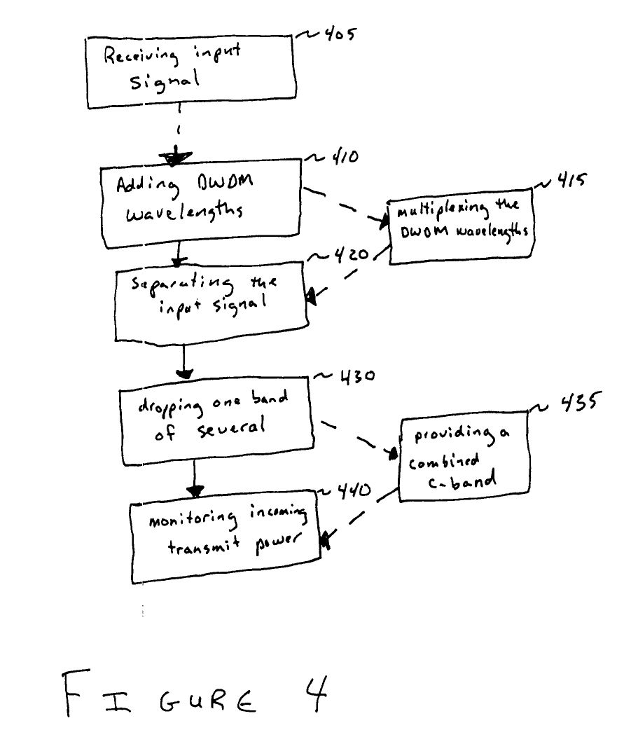

FIG. 4 illustrates another method according to another embodiment of the present invention. The method includes adding 410 dense wavelength division multiplexing wavelengths from a plurality of external nodes to an input signal received from an optical hub.

The method also includes separating 420 the input signal into a plurality of bands. The method further includes dropping 430 one band of the plurality of bands to the external nodes. The method additionally includes monitoring 440 incoming transmit power from the external nodes.

The method also includes terminating 450 local traffic from the external nodes. The method can also include receiving 405 the input signal from a port connected to the optical hub. The method can also include multiplexing 415 the dense wavelength division multiplexing wavelengths transmitted from the external nodes. The method can further include providing 435 a combined c-band to the optical hub.

The methods and figures described above illustrate steps in a particular order. There is, however, no requirement that the steps of the method be performed in the order shown, or necessarily as separate steps. Thus, for example, the separating 360 the incoming signal can include the separating 380 the base portion. Likewise, the illustration of steps above, whether connected by a solid or dashed line, does not indicate that the step is absolutely required. One of ordinary skill in the art would recognize that certain steps could be omitted under various circumstances without departing from the spirit and scope of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. An upgradeable optical hub, comprising:
a fiber-in interface;
a fiber-out interface;
a demultiplexer filter configured to drop a selected wavelength of an input optical signal received at the fiber-in interface;
a multiplexer filter configured to add a selected wavelength of an output optical signal to be provided at the fiber-out interface;
wide optical couplers configured to multiplex dense wavelength division multiplexing wavelengths and add them to the input optical signal;
a wide optical coupler configured to add a channel from a hub upgrade to the output optical signal;
a first control element configured to separate the input optical signal into a base portion and an upgrade portion, and to provide the upgrade portion at an output of the hub;
a second control element configured to receive an upgrade portion from an input of the hub and to combine it with the base portion;
an optical isolator connected to the first control element and configured to drop a band of the base portion;
a dropped band output configured to provide the band to one or more external nodes;
a power monitor configured to monitor transmit power from the one or more external nodes; and
a transceiver configured to provide a respective signaling channel to the one or more external nodes.

2. The hub of claim 1, wherein the hub is configured to connect to an optical backbone at the fiber-in interface and the fiber-out interface using two single mode fibers.

3. The hub of claim 1, wherein the demultiplexer filter is configured to drop a 1510 nm wavelength to a 2.67 Gbps small form-factor pluggable transceiver.

4. The hub of claim 1, wherein the multiplexer filter is configured to provide add a 1510 nm wavelength from a 2.67 Gbps small form-factor pluggable transceiver to the fiber-out interface.

5. The hub of claim 1, wherein the wide optical couplers are configured to multiplex dense wavelength division multiplexing wavelengths transmitted from the external nodes.

6. The hub of claim 1, wherein the wide optical coupler is configured to receive a multiplexed channel from the hub upgrade.

7. The hub of claim 1, wherein the first control element is configured to separate a c-band of the input signal into the base portion and the upgrade portion.

8. The hub of claim 1, wherein the second control element is configured to provide a combined c-band to the fiber-out interface.

9. The hub of claim 1, wherein the first control element is configured to separate the base portion into four bands, including the band that is dropped by the optical isolator, and to provide respective amplification for each band of the four bands.

10. The hub of claim 1, wherein the first control element comprises a variable optical element configured to ensure correct power levels.

11. The hub of claim 1, wherein optical power meters are provided before and after each linear optical amplifier, wherein the optical power meters are configured to monitor the gain of each amplifier, and wherein the optical power meters are configured to cooperate in generating an alarm if the linear optical amplifiers age or fail.

12. The hub of claim 1, wherein the band is a four-channel band.

13. The hub of claim 1, wherein first control element is configured to pass all bands, subject to further processing, except the band.

14. The hub of claim 1, wherein the power monitor is further configured to monitor a total incoming power from the hub upgrade.

15. The hub of claim 1, wherein the transceiver comprises four local 110 nm optical supervisory channel transceivers.

16. An optical hub upgrade, comprising:
wide optical couplers configured to multiplex dense wavelength division multiplexing wavelengths and add them to an input optical signal;
a first control element configured to separate an input upgrade portion from an optical hub into a plurality of bands and to provide proper amplification for each band;
a second control element configured to provide an output upgrade portion to an input of the optical hub for combination with a base portion;
an optical isolator connected to the first control element and configured to drop a band of the upgrade portion;
a dropped band output configured to provide the band to one or more external nodes;
a power monitor configured to monitor transmit power from the one or more external nodes; and
a transceiver configured to provide a respective signaling channel to the one or more external nodes.

17. The hub upgrade of claim 16, wherein the input signal is received from a port connected to the optical hub.

18. The hub upgrade of claim 16, wherein the wide optical couplers are configured to multiplex dense wavelength division multiplexing wavelengths transmitted from the external nodes.

19. The hub upgrade of claim 16, wherein the first control element comprises a variable optical attenuator configured to ensure correct power levels.

20. The hub upgrade of claim 16, wherein the second control element is configured to provide a combined c-band to the optical hub.

21. The hub upgrade of claim 16, wherein optical power meters are provided before and after each linear optical amplifier, wherein the optical power meters are configured to monitor the gain of each amplifier, and wherein the optical power meters are configured to cooperate in generating an alarm if the linear optical amplifiers age or fail.

22. The hub upgrade of claim 16, wherein the band is a four-channel band.

23. The hub upgrade of claim 16, wherein first control element is configured to pass all bands, subject to further processing, except the band.

24. The hub upgrade of claim 16, wherein the transceiver comprises four local 110 nm optical supervisory channel transceivers.

25. An optical hub system, comprising:
an upgradable optical hub comprising
a fiber-in interface,
a fiber-out interface,
a demultiplexer filter configured to drop a selected wavelength of an input optical signal received at the fiber-in interface,
a multiplexer filter configured to add a selected wavelength of an output optical signal to be provided at the fiber-out interface;
wide optical couplers configured to multiplex dense wavelength division multiplexing wavelengths and add them to the input optical signal,
a wide optical coupler configured to add a channel from a hub upgrade to the output optical signal,
a first control element configured to separate the input optical signal into a base portion and an upgrade portion, and to provide the upgrade portion at an output of the hub,
a second control element configured to receive an upgrade portion from an input of the hub and to combine it with the base portion,
an optical isolator connected to the first control element and configured to drop a band of the base portion,
a dropped band output configured to provide the band to one or more external nodes,
a power monitor configured to monitor transmit power from the one or more external nodes, and
a transceiver configured to provide a respective signaling channel to the one or more external nodes; and
the hub upgrade coupled to the upgradable optical hub comprising
a second plurality of wide optical couplers configured to multiplex second dense wavelength division multiplexing wavelengths and add them to an input optical signal,
a third control element configured to separate an input upgrade portion from the optical hub into a plurality of bands and to provide proper amplification for each band,
a fourth control element configured to provide an output upgrade portion to the wide optical coupler for combination with the base portion,
a second optical isolator connected to the third control element and configured to drop a second band of the upgrade portion,
a second dropped band output configured to provide the second band to a second one or more external nodes,
a second power monitor configured to monitor transmit power from the second one or more external nodes, and
a second a transceiver configured to provide a respective signaling channel to the second one or more external nodes.

26. A method, comprising:
providing fiber-in and fiber-out interfaces with an optical network;
dropping an incoming wavelength received at the fiber-in interface;
adding an outgoing wavelength to be provided to the fiber-out interface;
adding dense wavelength division multiplexing wavelengths from external nodes to the incoming wavelength;
adding upgrade wavelengths to the outgoing wavelength;
separating the incoming wavelength into base and upgrade portions;
providing the upgrade portion to a port for processing by an upgrade hub;
separating the base portion into a plurality of bands;
dropping one band of the plurality of bands to the external nodes;
monitoring incoming transmit power from the external nodes; and
terminating local traffic from the external nodes.

27. The method of claim 26, wherein the dropping the incoming wavelength comprises dropping a 1510 nm wavelength to a 2.67 Gbps small form-factor pluggable transceiver.

28. The method of claim 26, wherein the adding the outgoing wavelength comprises adding a 1510 nm wavelength from a 2.67 Gbps small form-factor pluggable transceiver to the fiber-out interface.

29. The method of claim 26, further comprising:
multiplexing dense wavelength division multiplexing wavelengths transmitted from the external nodes.

30. The method of claim 26, further comprising:
receiving a multiplexed channel from the hub upgrade.

31. The method of claim 26, wherein the separating the incoming wavelength comprises separating a c-band of the input signal into the base portion and the upgrade portion.

32. The method of claim 26, further comprising:
providing a combined c-band to the fiber-out interface.

33. The method of claim 26, wherein the separating the base band comprises separating the base portion into four bands, including the band that is dropped by the optical isolator, and providing respective amplification for each band of the four bands.

34. The method of claim 26, the monitoring further comprises monitoring a total incoming power from the hub upgrade.

35. A method, comprising:
adding dense wavelength division multiplexing wavelengths from a plurality of external nodes to an input signal received from an optical hub;
separating the input signal into a plurality of bands;
dropping one band of the plurality of bands to the external nodes;
monitoring incoming transmit power from the external nodes; and
terminating local traffic from the external nodes.

36. The method of claim 35, further comprising:
receiving the input signal from a port connected to the optical hub.

37. The method of claim 35, further comprising:
multiplexing the dense wavelength division multiplexing wavelengths transmitted from the external nodes.

38. The method of claim 35, further comprising:
providing a combined c-band to the optical hub.

39. An upgradable optical hub, comprising:
input interface means for communicating with a fiber network;
output interface means for communicating with the fiber network;
demultiplexer means for dropping a selected wavelength of an input optical signal received at the input interface means;
multiplexer means for adding a selected wavelength of an output optical signal to be provided at the output interface means;
a plurality of wide optical coupling means for multiplexing dense wavelength division multiplexing wavelengths and adding them to the input optical signal;
a wide optical coupling means for adding a channel from a hub upgrade to the output optical signal;
first control means for separating the input signal into a base portion and an upgrade portion, and for providing the upgrade portion at an output of the hub;
second control means for receiving an upgrade portion from an input of the hub and combining it with the base portion;
optical isolation means for dropping a band of the base portion;
dropped band output means for providing the band to one or more external nodes;
power monitor means for monitoring transmit power from the one or more external nodes; and
a transceiver means for providing a respective signaling channel to the one or more external nodes.

40. An optical hub upgrade, comprising:
a plurality of wide optical coupling means for multiplexing dense wavelength division multiplexing wavelengths and adding them to an input optical signal;
first control means for separating an input upgrade portion from an optical hub into a plurality of bands and for providing proper amplification for each band;
second control means for providing an output upgrade portion to an input of the optical hub for combination with a base portion;
optical isolation means for dropping a band of the upgrade portion;
dropped band output means for providing the band to one or more external nodes;
power monitor means for monitoring transmit power from the one or more external nodes; and
a transceiver means for providing a respective signaling channel to the one or more external nodes.
